(19) United States
(12) Patent Application Publication
(10) Pub. No.: US 2017/0104829 A1
(43) Pub. Date: Apr. 13, 2017

(54) NETWORK RESOURCE CRAWLER WITH MULTIPLE USER-AGENTS

(71) Applicant: Ehrlich Wesen & Dauer, LLC., Pittsburgh, PA (US)

(72) Inventor: Jeremy A. Degroat, Panama City, FL (US)

(21) Appl. No.: 15/291,008

(22) Filed: Oct. 11, 2016

Related U.S. Application Data
(60) Provisional application No. 62/240,246, filed on Oct. 12, 2015.

(51) Int. Cl. H04L 29/08; H04L 12/911

(52) U.S. Cl. CPC H04L 67/146; H04L 47/82

(57) ABSTRACT

Systems and methods for crawling network resources with multiple user-agents and configurations in order to manually or automatically adjust the performance, accuracy, and other properties of the crawl being executed. The methods include several complimentary strategies for obtaining user-agent flexibility.

### PRIORITY

This application claims priority to U.S. Provisional Application 62/240,246, filed Oct. 12, 2015, and titled “Network Resource Crawler with Multiple User-Agents . . . ,” which is incorporated in its entirety herein.

### BACKGROUND

A computer network is a telecommunications network which allows various computing devices to exchange data. The network consists of both the interconnecting hardware (routers, switches, hubs, cables, antennas, etc.) and the computing devices it connects. Examples of computer networks range from two computing devices connected directly via a cable or wireless channel to the global system of interconnected computer networks known as the Internet.

The most common kind of network resource is a web page, which is an electronic document written in HTML that contains content, layout information, and a set of resources to automatically download and incorporate as embedded objects, as well as links (aka, “hyperlinks”) to other pages and resources. Web pages and their embedded objects are served, not surprisingly, by a web server. Non-HTML documents, such as PDF files, Word documents, Excel spreadsheets, and so on, may also be provided using similar mechanisms. These and other network resources may take simpler forms, but often also include content with links to additional resources.

Typically, a network resource is referred to by its Uniform Resource Locator (URL). A URL is a symbolic address that both identifies a resource and indicates a location or means of access. It usually specifies a protocol, a symbolic name of the machine running the server program, and a path or other parameters needed to access the exact resource requested.

A user-agent is a software program or component that acts as a client in a network protocol to access resources provided by servers. This is usually done on behalf of a user, but may be driven by another program. Examples include web browsers, FTP utilities, chat clients, video players, network-enabled mobile applications and games, and various command-line tools, but also cover finer-grained components such as those found in software libraries, frameworks, and web crawlers.

When manually controlled, a user may provide a URL as input or click a link to instruct the user-agent to download, access, or otherwise interact with a particular network resource. When automated, a program may start from one or more URLs and use the user-agent to explore and analyze network resources. Such programs are used to index and search documents, aggregate information, test functionality and performance, monitor availability, scan for security vulnerabilities, and many other uses.

A web crawler is an example of user-agent automation that performs an exploration within the context of web resources. An operator provides a set of web pages (as URLs) and the crawler sequentially browses the web resources specified, adding new web pages as they are identified from the crawled documents. Information about the pages is then sent to an external program for further processing, such as indexing for a search engine. Web crawlers are generally optimized for throughput in order to process as many pages per time unit as possible. This is often done at the expense of accuracy and thoroughness.

Web application scanners are similar to web crawlers but typically analyze a much smaller section of the Web, such as a single website or web application.

There is tremendous diversity in the nature, forms, and delivery of network resources. Even within a single distributed system, such as the Web, that uses a common protocol and generally accepted standards, each website or web application may look nothing like its neighbor in terms of its structure, size, complexity, and constituent technologies. However, there is more to the Internet than websites. Functionality and services are provided across a variety of mediums, each of which has performance, security, usability, availability, and other requirements. Further, there is a wealth of information provided by others to be explored and utilized.

Conventionally, both web crawlers and web application scanners typically use a single user-agent for downloading and accessing resources, optimizing for the expected case. But because of the disparity of network resources, these designs may suffer huge performance or accuracy penalties in unanticipated cases, making them unsuitable for a wider range of related uses.

Today, there are hundreds of uses for web crawlers and scanners, and thousands of products that contain them. Though the purposes vary widely, the crawler components exhibit similar architectures, with only minor variations for each solution. However, in spite of their similarities, crawlers are often coded from scratch, a new wheel reinvented every day. Because these offerings tend to focus on a single issue, customers must purchase several products, and therefore several redundant crawlers, to accomplish all of their objectives.

### BRIEF SUMMARY

Systems and methods are disclosed herein for crawling network resources with multiple user-agents and configurations in order to manually or automatically adjust the performance, accuracy, and other properties of the crawl being executed. The methods include several complimentary strategies for obtaining user-agent flexibility. For example, methods include an instruction set for selecting a specific user agent from a plurality of user agents to retrieve and parse a network resource, or include an instruction set for iteratively selecting user agents from a plurality of user agents to achieve a desired crawl response.

### BRIEF DESCRIPTION OF THE DRAWINGS

FIGS. 1-3 illustrate exemplary modular crawling embodiments in which different user agents may be used in one or more combinations to achieve different crawl criteria.

FIG. 4A is a block diagram of a distributed computer system illustrating example features of an exemplary embodiment of the invention.

FIG. 4B is a schematic of an exemplary computing device that can facilitate network resource crawling as well as host and serve network resources.

FIG. 5A is a data structure containing rules for matching patterns in URLs and content with ideal user-agents.

FIG. 5B is a flow diagram depicting detail of the process step for selecting an appropriate user-agent based on URL alone.

FIG. 6 is a flow diagram depicting an exemplary embodiment of the invention.

FIG. 7 is a flow diagram depicting detail of the process step for selecting an appropriate user-agent based on URL and content from a previous download or access.

FIG. 8 is a flow diagram depicting an exemplary embodiment of the invention.

FIG. 9 is a flow diagram depicting an exemplary embodiment of the invention.

FIG. 10 is a flow diagram depicting an exemplary embodiment of the invention.

### DETAILED DESCRIPTION OF SPECIFIC EMBODIMENTS

The present invention is now described with reference to the drawings, wherein like numbers are used to refer to like elements throughout. Numerous specific details are offered throughout the description in order to make clear the nature and basis of the invention. However, it is not intended for these details to limit the scope of the invention in any way. Specific functional examples are associated with individual exemplary embodiments. Each embodiment, including each function or component may be combined in any combination to achieve the desired result, and each embodiment is not intended to stand in isolation. Exemplary methods are disclosed herein with exemplary steps in a given order, described sequentially. However, the steps may be integrated, divided, duplicated, deleted, run sequentially, concurrently, or otherwise combined, reconfigured, or performed in any combination as would be understood by a person of skill in the art.

The disclosed embodiments relate generally to web crawlers, website analysis tools, and web data mining, but are not limited to web resources, and instead apply broadly to any network resources. In particular, the disclosed embodiments relate to systems and methods for exploring and analyzing various network resources and their relationships through the use of multiple user-agents with varying capabilities and configurations.

Exemplary embodiments include an adaptive or dynamic network crawler that can be responsive to different sizes of crawls, functions, and purposes. For example, a web crawler architecture is disclosed in which the architect can make a set of design choices and compromises that are optimized for a specific use, and the architecture of the platform implements the selection to achieve those objectives by selecting a subsection of crawling algorithms and/or selection of specific crawlers or user agents from a global set of crawling algorithms and/or user agents. Exemplary embodiments include a manual, an automatic, or a combination architect that selects a preferred design choice, either entirely automatically, or based on any combination of inputs from a physical user architect. For example, an adaptable crawler engine and architecture disclosed herein features pluggable modules for different aspects of its operation, from hostname resolution and fetching to parsing and browser simulation.

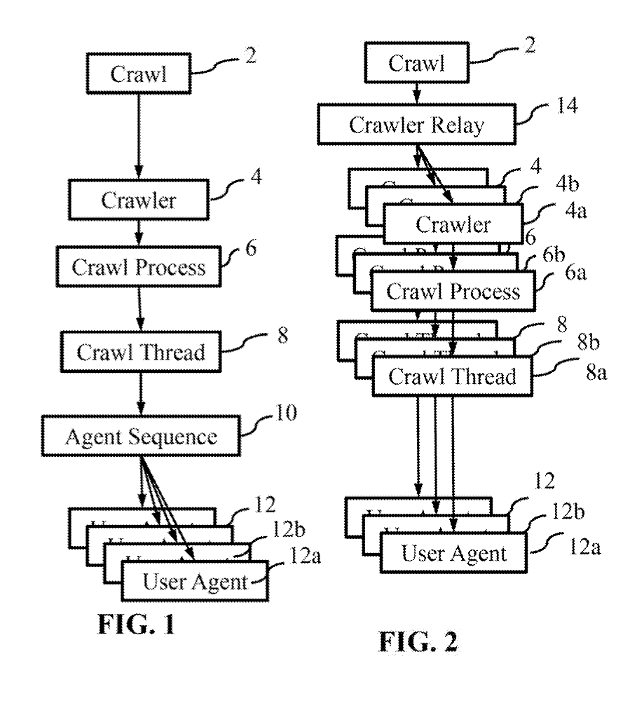

FIGS. 1-3 illustrate exemplary modular crawling embodiments in which different user agents may be used in one or more combinations to achieve different crawl criteria. FIG. 1 illustrates an exemplary escalation model in which the algorithm fetches, parses, and analyzes each page progressively with more sophisticated user agents, depending on a criteria set. FIG. 2 illustrates an exemplary delegation model in which multiple, independent crawlers (each with a fixed user agent) are assigned to a single crawl, and a crawl relay manages the handoffs between them. Under either embodiment, each crawl 2 is performed by exemplary crawler 4 as described herein. The crawler defines a crawl process 6. Each crawl strategy uses a user agent 12 that performs the function of fetching a document from a network resource and parsing the document. The crawl thread 8 controls which document is fetched by the user agent 12. After the user agent 12 retrieves a document, the parsed information is provided to the crawl process to determine whether additional iterations are desired. The system may determine whether a crawl is sufficient in a number of ways. The system may review an overall crawl or may determine performance of an individual crawl task or fetch and parse of a particular document. In the case of a crawl task, the termination events may be based on an analysis of the crawl results. Alternatively or in addition thereto, the termination event may be based on a repeat selection of a user agent to perform the crawl, when the user agent is iteratively determined based on optimization of crawl results to achieve a certain result. Other termination events may also be used.

For example, the crawler 4 may identify a specific page by the crawl thread 8 that is retrieved and parsed by the user agent 12. If additional links are identified from the crawl, then the link may be provided to the crawl thread 8 and the next page fetched and parsed by the user agent 12. If the crawl performed by the user agent 12 is insufficient to identify the desired information or define a document with sufficient particularity, then exemplary embodiments may be used to selectively and iteratively retrieve and/or parse the document from the network resource with a different user agent. Different user agents may be used until a document is parsed to sufficient particularity or all of the user agents have been used.

For example, the crawler 4 may select a first user agent to perform a crawl. The first user agent may be a default user agent to achieve a particular goal or may be based on the specific page to be crawled. In an exemplary embodiment, the first user agent is based on a host domain of the document. In an exemplary embodiment, the first user agent is based on optimizing the selected user agent to achieve a desired functional objective (e.g., crawl speed), based on a rule based selection of user agents according to attributes of the page (e.g., host domain), and combinations thereof. The results of the optimal user agent are returned and used to supplement the selection of the next optimal user agent. The document is iteratively crawled and additional user agents selected based on the document attributes and returned information, until a user agent is selected that has previously been employed or all user agents have been used.

Exemplary embodiments are described herein in terms of network resources and retrieving and parsing documents from a network resource. A network resource is any data or functionality that can be accessed via a network, and includes web pages, other web objects (e.g. images, scripts, applets, etc.), directories of files, audio and video streams, data services, email access, Internet chat channels, printer and other device functions, and remote system control interfaces, among many others. The software program that serves the resources to users on the network is called a “server,” and is itself a kind of network resource. As used herein, a document retrieved from a network resource is intended to include any object retrieved from the networked resource.

The exemplary embodiment of FIG. 1 uses an agent sequence 10 to select the desired user agent 12 or iterative user agents 12a, 12b to perform the fetch and parse on a given document identified by the crawl thread 8. The selection of user agent 12 by the agent sequence 10 is based on a set of rules. For example, multiple user agents may be available in which the first user agent 12a is a simple text based token process that is very fast, but does not use any java script interpretation. However, after the first iteration, the user agent 12a may have identified only a small number of links within the retrieved page, but a comparison to the java script on the document suggests that the document was incompletely or inadequately parsed. Therefore, the agent sequence selects the next user agent 12b to retrieve and parse the document, where user agent 12b may perform primitive java script processing, sacrificing speed for recognition. Therefore, exemplary embodiments may iteratively retrieve and parse a document and make an assessment as to the quality of the returned information or a desired level of confidence of the adequacy of the parse. The adequacy of the parse may be set on any parameter base to achieve a desired function of the crawl. As long as the confidence is below a threshold, then the agent sequence uses the next sequential user agent to retrieve and/or parse a document from a network resource. Once the document is parsed to a sufficient degree, then the crawl thread may identify the next document to retrieve and selects the desired starting user agent to iteratively parse the next document until a desired confidence is achieved in the completeness or the quality of the parse.

The selection of user agent 12 by the agent sequence 10 is based on any desired set of rules. In an exemplary embodiment, the set of rules may provide an optimal selection of a given user agent over all of the other user agents. For example, rules may be based on the document domain, document type, keyword matches, embedded object domains, performance of previous user agents, in line analysis of the fetch and parse from a user agent, and other rules to achieve a desired response. For example, the fetched information may be reviewed for keywords. In the case of a crawl for law enforcement, specific individual names or code words may be identified. When these names are observed in a document, a more sophisticated user agent may be desired to conduct a more comprehensive data retrieval. As another example, the embedded objects may be used to determine the respective domains. In an exemplary case, if a certain ad tracker is identified as an embedded object, a user agent simulating a full browser may be required to fully identify attributes of the embedded object. As another example, the performance of previous user agents may also be used. In an exemplary case, if a more complex user agent is used, but the page call exceeds a time out or takes a substantial amount of time, that user agent may be given a negative weight to discourage its use. Other examples include the use of in line analysis of the fetched and parsed information from a page. In an exemplary case, the fetched and parsed information may be analyzed at or proximate to the time of retrieval such that additional information may be obtained and used in selecting the next user agent. As an exemplary case, the fetched information may be analyzed to identify a vulnerability in the security of the document. Once a possible vulnerability is identified, then the more sophisticated user agents may be given greater weights in order to identify additional vulnerabilities. Any combination of rules may be used in which the system can compare patterns of the URL, document, and/or retrieved data in order to select an optimal user agent from the plurality of user agents.

Each of the rules may provide a straight or weighted factoring for a given user agent. For example, a rule may exist for a certain domain, such as a social media site, that if true for the retrieved document, would result in a heavily weighted affinity for a specific user agent, such as user agent 12a. After all of the rules are applied, the user agent may then be selected based on a weighted average from the factoring, a straight summation across each of the weighted factoring per user agent, the highest weighted factor for a given user agent, and any combination thereof, or other combination within the skill in the art to achieve the desired optimal selection of a user agent. The weighted factor may also include positive and negative weights, such that a weight may correlate to a preferred optimal user agent (having a positive weight) or may indicated a disfavored user agent (having a negative weight) for a given attribute or pattern. The user agents may be iteratively selected based on a set of rules to optimize a parse based on attributes of the document, outside information, retrieved information from a prior parse, objects from an architect, and any combination thereof, or described herein.

The exemplary embodiment of FIG. 2 uses a series of crawlers 4a, 4b in which each crawl thread 8a has only a single user agent 8a available to retrieve and parse a document. The crawl relay 14 acts similar to the agent sequence 10 to analyze the parsed information from an iteration of a retrieve and parse from a given user agent and determine whether the document was parsed to a sufficient confidence or select the optimum user agent. Alternatively, the crawl process 6 or other lower level crawl component may make the determination and simply send the selection to the crawler relay 14 to merely implement the selection. Therefore, the crawler 4, crawl process 6, and/or crawl thread 8 may have access to the set of selection rules in order to iteratively determine the optimum user agent based in part on the retrieved information. Each crawl thread may be associated with different user agents of different sophistications to perform different qualities of retrieve and parse functions.

Exemplary embodiments may dictate a set of rules to determine the selection of user agents. In an exemplary embodiment, the user agents may be assigned sequentially based on a given crawling parameter. A similar selection process may be implemented as described above for FIG. 1. The selection of user agents may be static or dynamically selected. For example, upon a sequential iteration of a document from a first network resource an end user agent may have been sufficient to achieve the confidence goals. The rules base may thereafter be updated to indicate an associated weight for the given user agent based on the domain, document attribute, or other pattern. Therefore, the system may determine that the same user agent may start the sequential iteration of the next document or may select a user agent with tradeoffs between the original user agent and final user agent of the iterative analysis of the first document. As another example, a user input may be used to dictate one or more crawling parameters to set the user agent selection criteria. Accordingly, the set of rules under any embodiment described herein, may be based on an entered rule base by a physical architect, may be a selection of rules preprogrammed and selected by a user, may be based on direct or indirect information retrieved from a user, may be based on previous experience or performance of the system, may be based on machine learning, and any combination thereof. Accordingly, exemplary embodiments may be fully autonomous, semi-autonomous, user defined, and combinations thereof.

Exemplary embodiments may dictate a set of rules to determine a desired confidence level in which the iterations of the user agent parsing are compared. The desired confidence may be based on any design parameter relevant to a design architect. The desired confidence may be purely temporal, in which the user agents are iteratively run until a parsing time limit is reached regardless of the quality of the retrieved information. The desired confidence may also be based on a comparison of document attributes. For the example described above in which the number of links identified by the parse was compared to the amount of java script on the page, the analyzed information from a document may be compared or a document attribute to determine a confidence level of the parse. The confidence level may be on the quantity and/or quality of a parse. The confidence level may be based on the repeat selection of the optimal user agent.

The embodiments of FIGS. 1 and 2 may be used in isolation or in combinations. In an exemplary embodiment, the delegation model of FIG. 2 may be used to house an individual user agent on separate components, machines, or resources to compliment the functions of the specific user agent. For example, for the above described text based token process user agent, the associated resources in memory is very minimal, while a full web browser user agent is exceptionally memory reliant. Therefore, a first user agent may be provided on a first machine with minimal memory, while a second user agent may be provided on a second machine with substantial memory compared to the first machine. In an exemplary embodiment, the escalation model of FIG. 1 may permit multiple user agents to be stored or used from a single component, machine, or resource.

For example, FIG. 3 illustrates an exemplary hybrid of FIGS. 1 and 2 in which a crawl thread 8 may have access to a single user agent 12 or a plurality of user agents 12a1, 12a2, 12a3. Different combinations of user agents and intervening crawl components from user agent(s) to crawler relay may be used and are contemplated within the scope of the present invention. In an exemplary embodiment, user agents may be grouped by crawl thread to maximize computing resources associated with the different user agents. For example, user agents 12b1 and 12b2 may require minimal memory space and can therefore be associated on a processing device having reduced or minimal accessible memory. Accordingly, the user agent may be supported by the most appropriate hardware.

Exemplary embodiments may include a software platform on which any internet resource crawling, analysis, management, or enhancement task can be automated and actualized. Exemplary embodiments enable modifiability and end-user customization at different levels. For example, exemplary embodiments permit an architect to input a variety of inputs, such as selecting specific crawling priorities or agents, while other exemplary embodiments permit fully autonomous decision selections. Embodiments may include any combination in between by receiving from a user one or more purpose, objective, answer to a question, user agent, etc. Exemplary embodiments of the system may then be configured in response thereto. Among its many characteristics, exemplary embodiments can use a hybrid user-agent model that permits large scale crawling with situational use of full browser rendering to analyze more sophisticated web applications.

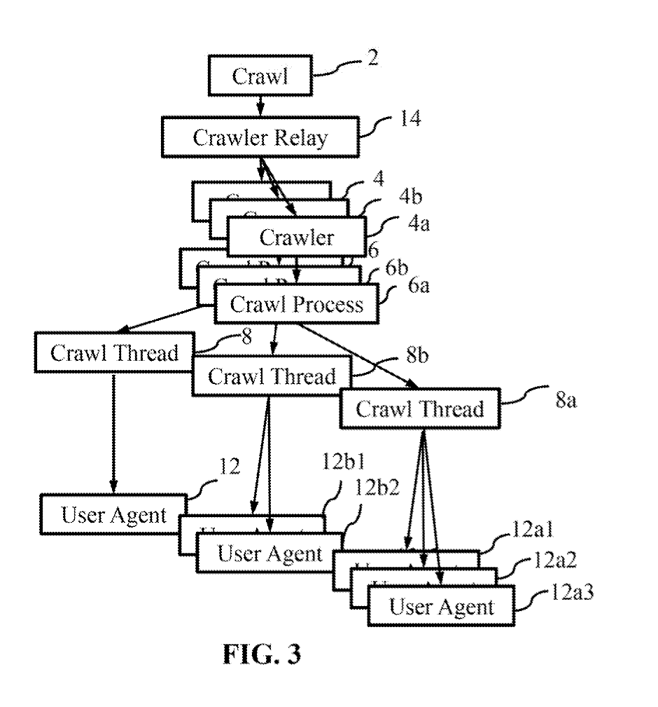

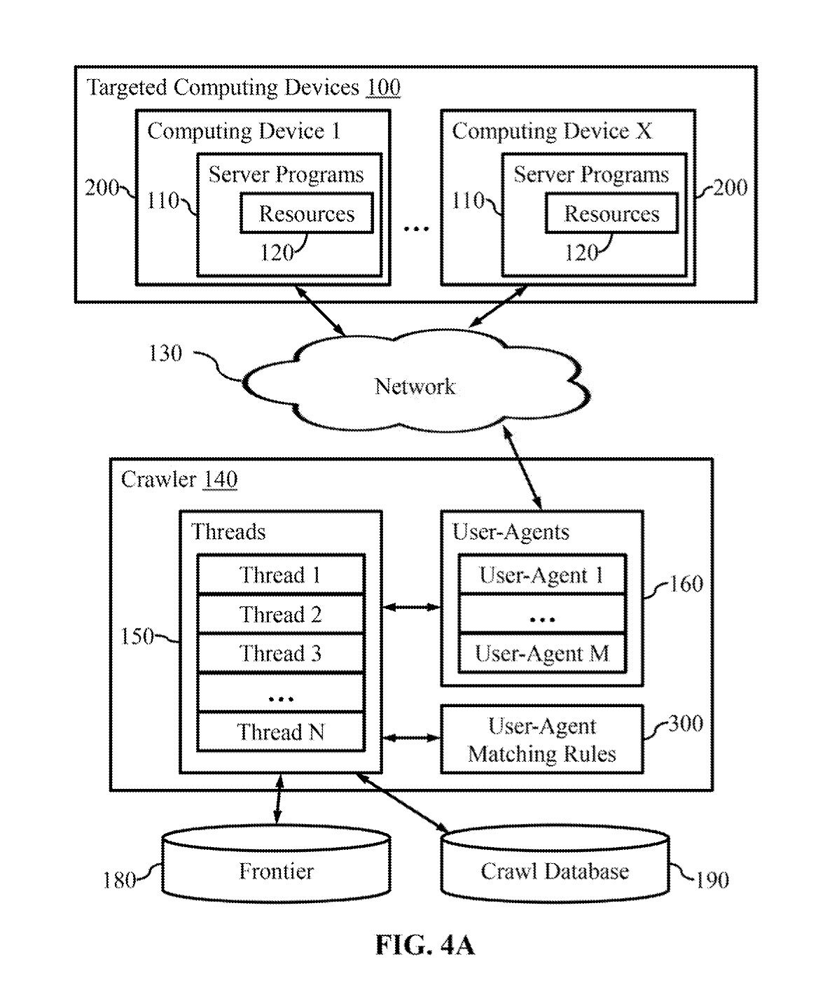

An exemplary crawler is illustrated in FIG. 4A, showing a set of targeted computing devices 100 being accessed via a network 130 by a crawler 140 component, which receives URLs from a Frontier 180 data structure and stores results in a crawl database 190.

The individual computing devices 200 each host a set of server programs 110 which serve various network resources 120.

The crawler 140 operates a number of crawling threads 150 and has access to a pool of user-agents 160. Each crawler 140 maintains a data structure of user-agent matching rules 300, which it employs to determine the appropriate user-agent to use when accessing a resource, according to some embodiments.

FIG. 4B illustrates a simplified general-purpose computing device on which various embodiments and elements of the network resource crawler described herein may be implemented. A computer that implements the crawler must have sufficient computational capability and system memory to run the necessary threads and contain the data structures needed. The computational capability is generally illustrated by one or more processing unit(s) 410 in communication with system memory 420 via a system bus 430. In addition, the computing device of FIG. 4B may include other components, such as, an input/output controller 440 which is used to manage interactions with devices outside of the computing device. These devices may include input components 450, such as mouse, keyboard, touchscreen, etc., and output components 456, such as a display, speakers, etc. The computer device 400 may also contain at least one communications device 260, such as wired or wireless network interfaces, in order to access network resources and retrieve and parse documents from network resources. Input/Output controllers 440, input devices 450, output devices 456, and communications devices 460 for general-purpose computers are well known to those skilled in the art, and will not be described in detail herein. The computing device of FIG. 4B may also include storage controllers 470 used to connect the system to diverse kinds of storage media, such as disk storage 480, such as hard drives, and removable media 490, such as CD-ROM, DVD-ROM, USB drives, etc. These storage media can be used to store computer-readable or computer-executable instructions, data structures, program modules, or other data.

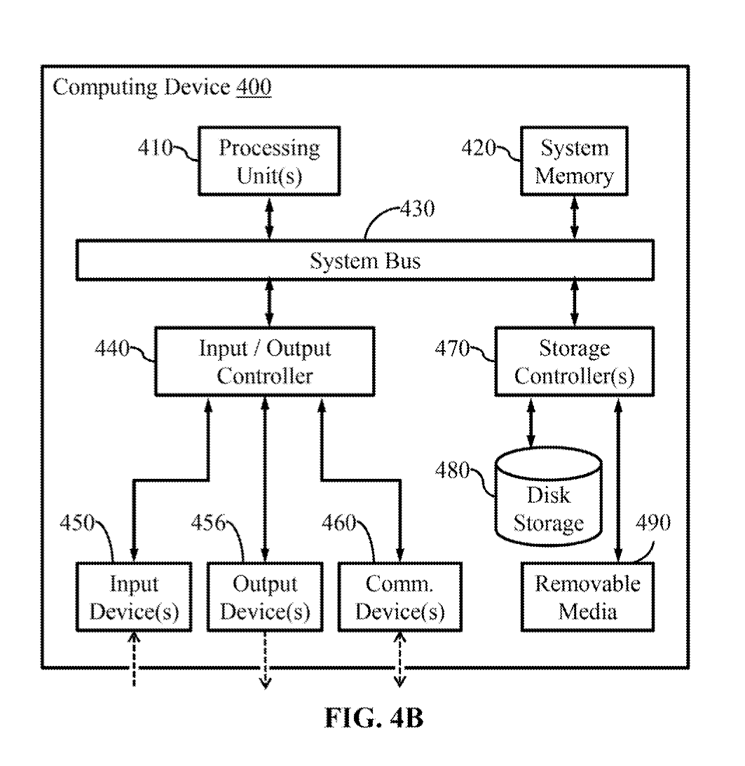

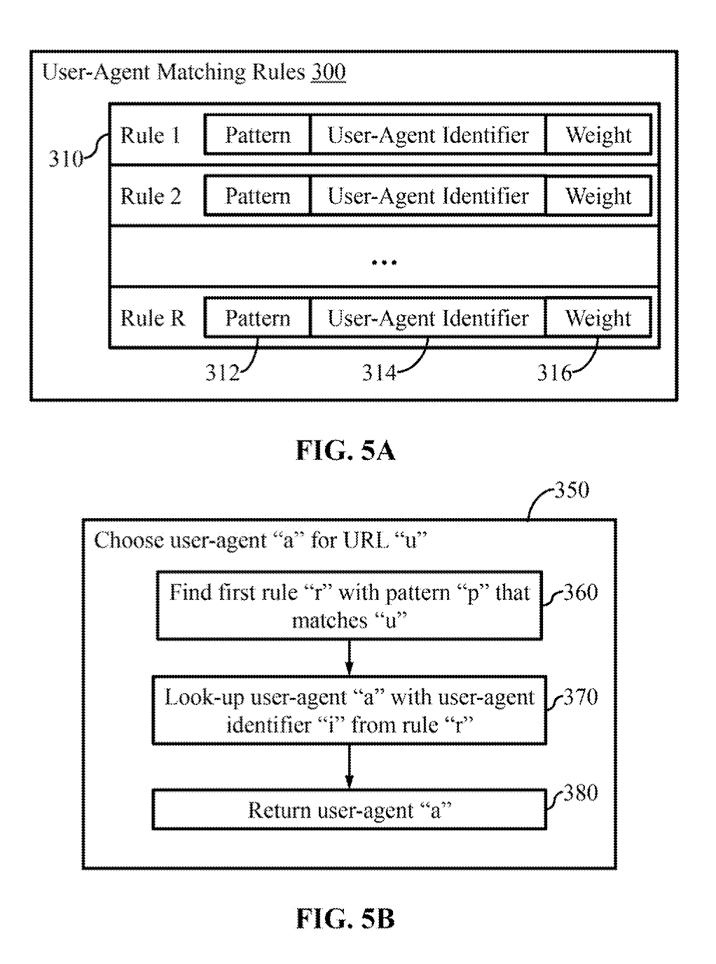

FIG. 5A is a data structure containing rules for matching patterns in URLs and content with ideal user-agents. The data structure shown is an ordered list of rules 310. Each rule contains a pattern 312 which can be used to match a URL or content, a user-agent identifier 314 which specifies a particular user-agent type and configuration, and a weight 316 to use in various scoring schemes.

For example, a first pattern may be a default selecting a given user agent with a weight of 50 (where weights range from 1-100). Other patterns may be based on page types. Therefore, documents, videos, websites, etc. may each define a pattern and the same or different user agent may be associated with each respectively, and a given weight assigned such as 95. Other patterns may be based on a domain name. A social media domain may provide a weight to a specific user agent optimal for social media content at 75. Any number of rules defining patterns, an associated user agent identifier, and a weight may be used.

FIG. 5B is a flow diagram depicting detail of the process step for selecting an appropriate user-agent based on URL alone. This step is used when a thread from a specific embodiment of the invention wishes to choose an initial user-agent “a” based on a given URL “u” (350). First, the executing thread searches consecutively through the list of rules until it finds the first rule “r” with a pattern “p” that matches the URL (360). If no rule is found, an exception must be thrown, to be handled by the caller. If “r” is found, then the user-agent identifier “i” for rule “r” is used to look up and get the corresponding user-agent “a” from a pool of available user-agents (370). The located user-agent “a” is then returned to the caller (350).

For example, the different patterns associated with a page may identify any number user agents with respective weights. To determine which user agent is optimal, the weighted factoring may be used in any combination. For example, the user agent associated with the one rule having the greatest weight can be used, a weighted average of the factoring may be used to select the user agent, or a straight sum may be made across the weights for respective user agents and the user agent associated with the highest weighted sum is selected. Any statistical determination may be used to select an optimal user agent.

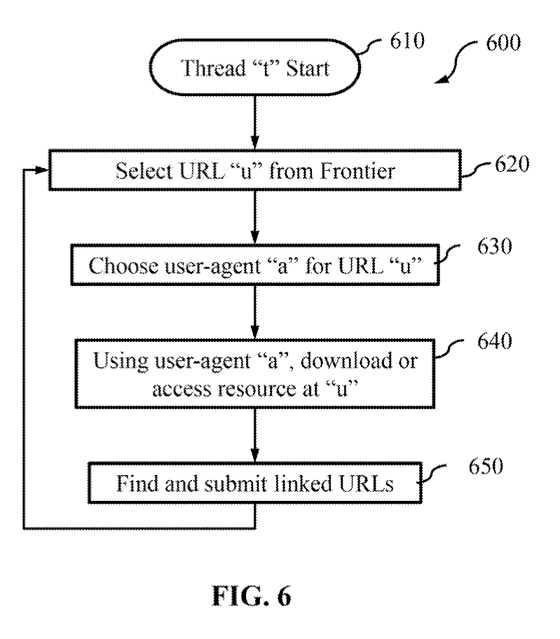

FIG. 6 is a flow diagram 600 depicting an exemplary embodiment of the invention. It describes a situation where the user-agent for downloading or accessing a URL is chosen based on the URL alone. First, at step 610 a threat “t” starts. Then, at step 620, the thread “t” begins by selecting a URL “u” from the Frontier data structure 180. At step 630, the thread “t” then chooses a user-agent “a” 160 for URL “u”, using the method described in detail in FIG. 5B. At step 640, once a user-agent has been chosen, it is used to download or access the resource at “u”. Then thread “t” processes the results, stores data in the crawl database, and searches for additional URLs, which are submitted to the Frontier 180. The thread then loops back to step 620.

This example may be the first rule based optimal selection of a user agent. For example, because the page has not been parsed, the selection is made only on attributes of the page known including the URL. The selection of the user agent can select an optimal agent by matching patterns associated with the URL, such as the domain name.

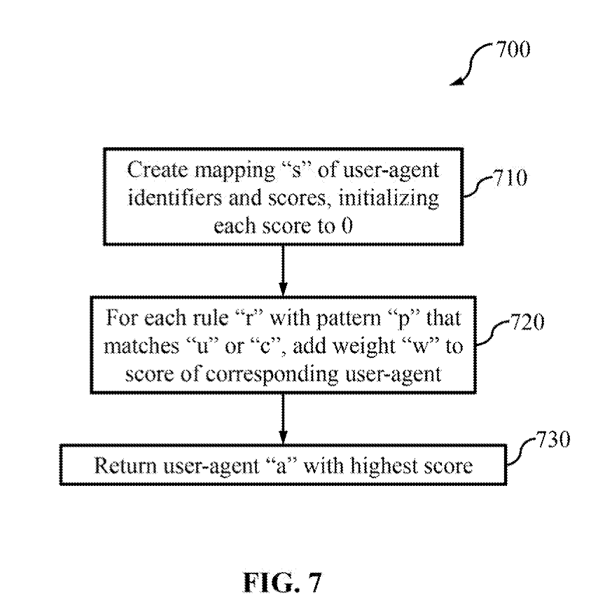

FIG. 7 is a flow diagram 700 depicting detail of the process step for selecting an appropriate user-agent based on URL and content from a previous download or access. This method may be used when a thread from a specific embodiment of the invention wishes to choose an alternative user-agent “a” based on a given URL “u” and any content “c” from a previous access using another user-agent. To begin at step 710, the calling thread creates a mapping “s” of user-agent identifiers and scores, each initialized to 0. The thread then searches at step 720 consecutively through the list of rules, and for each rule “r” with pattern “p” that matches “u” or “c”, the weight “w” for that rule is added to the score of the corresponding user-agent identifier “i”. After searching the entire list, at step 730, the user-agent “a” corresponding to the user-agent identifier “i” with the highest score is returned.

This example may be the sequential step after that of FIG. 6 as additional information is available to make a selection of an optimal user agent to perform the next parse. In this case, patterns as described in FIG. 5A are based on the page attributes, such as the domain, but may also be based on retrieved data, such as content types (video, embedded texts, etc.). Therefore, as more patterns match both the URL information and information associated with the retrieved content, the desired user agent and dictated by the sum of the associated weights of the matched patterns may indicate a different user agent for making the crawl. The selection continues to determine an optimal user agent based on successive pieces of retrieved information in conjunction with the previously used patterns to determine the optimal user agent for a crawl. The system then continues to select user agents and perform additional crawls until the same user agent is selected for a crawl, as a repeat user agent means additional information should not be retrieved and the page has been sufficiently parsed based on the available user agents.

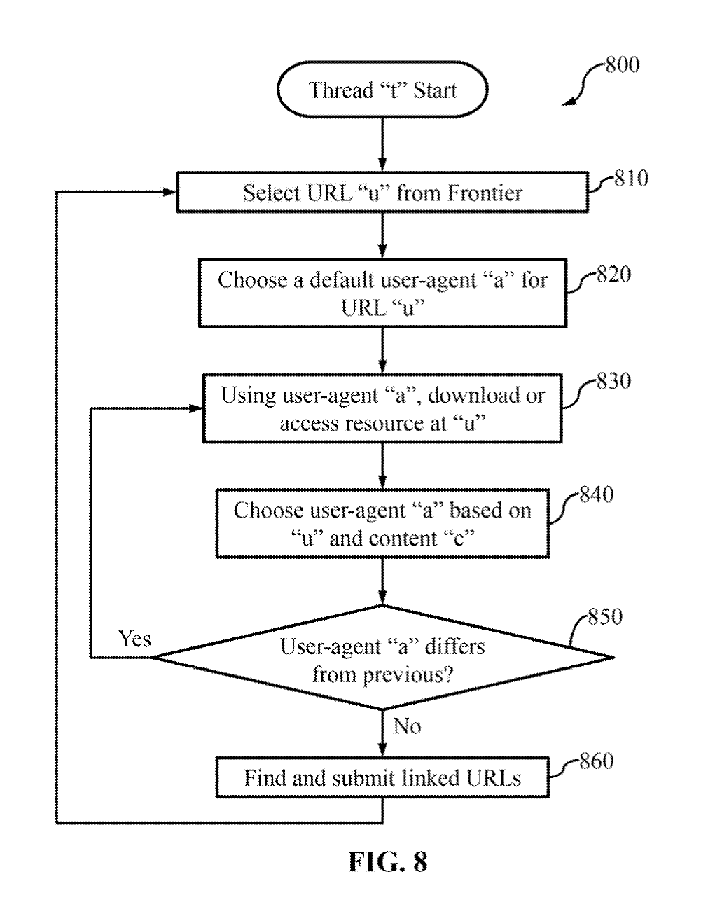

FIG. 8 is a flow diagram 800 depicting an exemplary embodiment of the invention. This embodiment describes an escalation strategy where the crawling thread continually adjusts the user-agent being used to download or access the URL (based on the URL and its previously downloaded contents) until satisfied with the results, similar to that described above with respect to FIG. 1.

In FIG. 8, at step 810, the thread “t” begins by selecting a URL “u” from the Frontier data structure. At step 820, the thread “t” then chooses a default, initial user-agent “a” for processing “u”. Once a user-agent has been chosen, at step 830, it is used to download or access the resource at “u”. At step 840, the thread “t” then attempts to choose an alternative user-agent “a” based on “u” and the contents “c” just downloaded, using the method described in detail in FIG. 7. Next, at step 850 it is determined if the user agent “a” differs from previous user agents. If user-agent “a” differs from the previous user-agent, then control returns to step 830 and “a” is used to download or access “u”. Else at step 860, thread “t” processes the results, stores data in the crawl database, and searches for additional URLs, which are submitted to the Frontier. The thread then loops back to step 810.

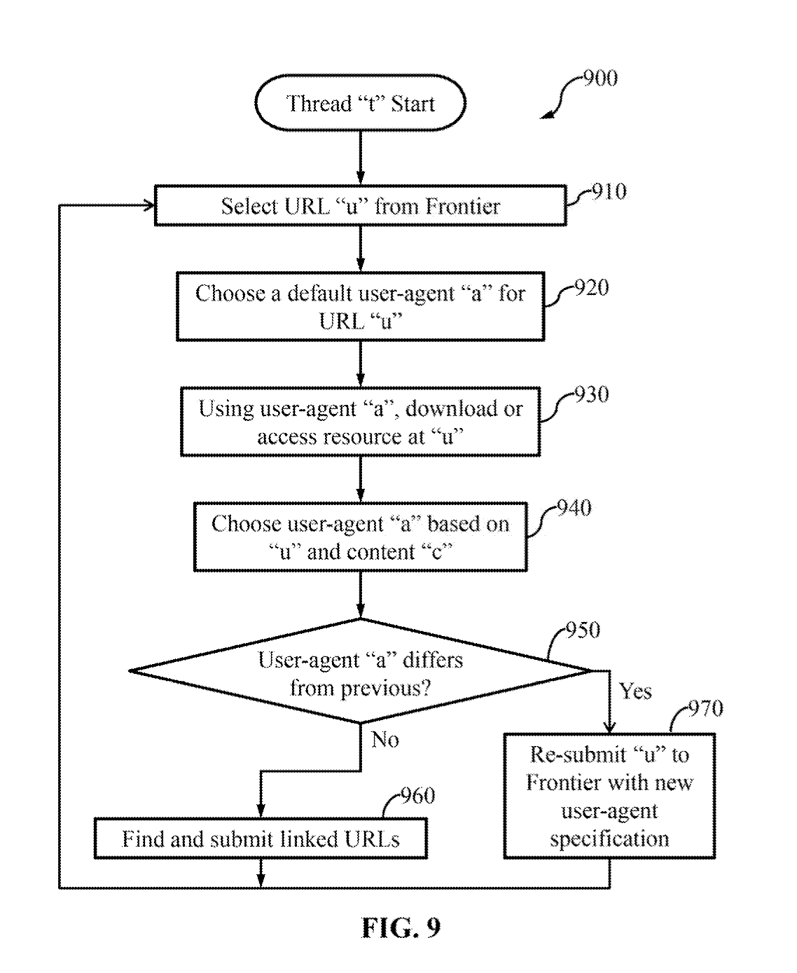

FIG. 9 is a flow diagram 900 depicting an exemplary embodiment of the invention. This embodiment describes a delegation strategy where the crawler makes one attempt to download or access the resource at a URL, and if not satisfied, re-submits the URL to the Frontier with an alternative user-agent specification, similar to that described in FIG. 2.

In FIG. 9, at step 910, the thread “t” begins by selecting a URL “u” from the Frontier data structure. The thread “t” then chooses a default, initial user-agent “a” for processing “u” at step 920. Once a user-agent has been chosen, at step 930, it is used to download or access the resource at “u”. The thread “t” at step 940 then attempts to choose an alternative user-agent “a” based on “u” and the contents “c” just downloaded, using the method described in detail in FIG. 7. At step 950, the user-agent “a” is determined if it is different from a previous user agent. If user-agent “a” differs from the previous user-agent, then the thread re-submits “u” to the Frontier with the user-agent specification identified in step 970, and control returns to step 910. Else at step 960, thread “t” processes the results, stores data in the crawl database, and searches for additional URLs, which are submitted to the Frontier. The thread then loops back to step 910.

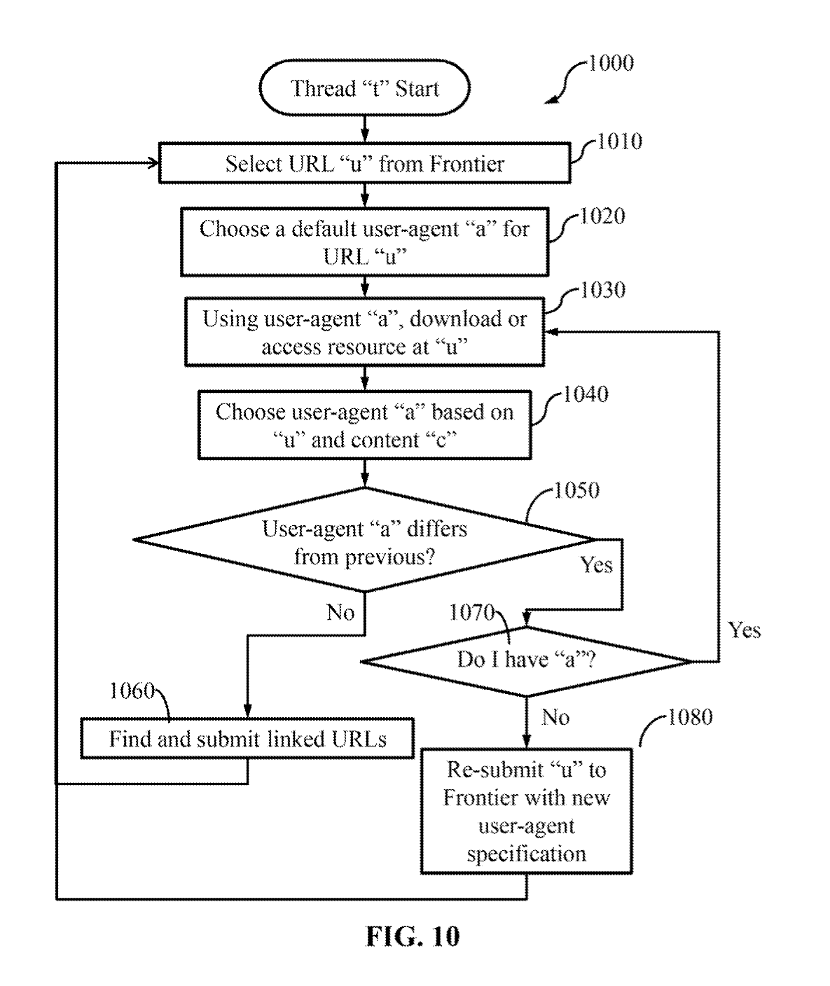

FIG. 10 is a flow diagram 1000 depicting an exemplary embodiment of the invention. This embodiment describes a combination strategy where the crawling thread continually adjusts the user-agent being used to download or access the URL (based on the URL and its previously downloaded contents) until satisfied with the results, or it recognizes the need for use of a user-agent that it does not possess, in which case it re-submits the URL to the Frontier with the alternative user-agent specification.

In FIG. 10 at step 1010, the thread “t” begins by selecting a URL “u” from the Frontier data structure. The thread “t” at step 1020 then chooses a default, initial user-agent “a” for processing “u”. Once a user-agent has been chosen, it is used to download or access the resource at “u” at step 1030. At step 1040, the thread “t” then attempts to choose an alternative user-agent “a” based on “u” and the contents “c” just downloaded, using the method described in detail in FIG. 7. The user agent “a” is then compared to previous user agents at step 1050. If user-agent “a” does not differ from the previous user-agent, then at step 1060, thread “t” processes the results, stores data in the crawl database, and searches for additional URLs, which are submitted to the Frontier. Else at step 1070, the crawler determines if user agent “a” is available. If at step 1070 this crawler node has user-agent “a” available, control returns to step 1030 and “a” is used to download or access “u”. Else at step 1080, the thread re-submits “u” to the Frontier with the user-agent specification identified in step 500, and control returns to step 810.

The disclosed rule sets embodied in exemplary FIGS. 6-10 may be used in any combination with any combination of hardware, such as those suggested by FIGS. 1, 2, and combinations thereof. For example, exemplary rules sets may be used to select a given user agent from a plurality of user agents. The rules sets may be used by the agent sequence 10 within the crawl thread 8 to select a user agent from a plurality of user agents available to the crawl thread, or may be used at the crawler relay 14 to select a crawler associated with a single crawl thread and user agent among a plurality of crawlers.

Exemplary embodiments are described herein which use a rule based selection criteria for identifying one or more user agents to use alone or iteratively to retrieve and parse an identified network resource. Exemplary embodiments may therefore be used to standardize methods and products that permit the unified exploration of disparate network resources within a single user interface or library for multi-disciplinary assessment and knowledge discovery. Exemplary embodiments include a common crawler architecture that could adapt its functional and extra-functional properties to match the use case at hand, without building a new crawler for each.

1. A method for exploring a remote network resource, comprising:
selecting a URL from a data structure containing a plurality of URLs ready for action;
obtaining a first set of rules that define a set of weighting factors for selecting an optimal user agent for exploring the remote network resource from a plurality of user agents;
choosing a first user agent from the plurality of user agents for exploring a network resource associated with the URL, wherein the choosing is based on the first set of rules and an attribute of the URL;
accessing the network resource corresponding to the URL with the first user agent;
retrieving content from the network resource corresponding to the URL;
processing the network resource for a set of additional URLs; and
submitting the set of additional URLs to a URL manager.

2. The method of claim 1, wherein, after the accessing and processing of the network resource, the method further comprises:
choosing an alternative user-agent from the plurality of user agents using the first set of rules, wherein the choice is based on the attribute of the URL and the retrieved content from the network resource;
accessing the network resource corresponding to the URL with the alternative user agent; and
retrieving additional content from the network resource corresponding to the URL.

3. The method of claim 2, wherein if the alternative user agent is different from the first user agent, then the URL is resubmitted to the URL manager with an alternative user agent specification.

4. The method of claim 2, wherein determining whether the alternative user agent is available to a present controller, and if available, then proceeding with the accessing of the network resource corresponding to the URL with the alternative user agent.

5. The method of claim 4, wherein if the alternative user agent is determined to not be available to the present controller, then before the accessing of the network resource with the alternative user agent, the URL is resubmitted to the URL manager with an alternative user agent specification.

6. The method of claim 2, wherein, after the accessing of the network resource by the alternative user agent, the method further comprises:
iteratively choosing another user agent from the plurality of user agents using the first set of rules; accessing the network resource corresponding to the URL with another user agent; and retrieving additional content from the network resource corresponding to the URL, wherein the choice is based on the attribute of the URL and the retrieved additional content from the network resource, wherein the iterative selection continues until a same user agent is chosen or each of the plurality of user agents have been used.

7. The method of claim 1, wherein the first set of rules comprise: keyword matches, document domain, document type, embedded object domains, previous performance of a user agent from the plurality of user agents, in line analysis of retrieved information, and combinations thereof.

8. A machine for exploring and analyzing remote network resources, comprising:
at least one CPU for processing data and instructions;
a plurality of threads of execution that are executed by the at least one CPU;
a memory for storing a plurality of URLs ready for action, a plurality of pattern-matching rules, and a plurality of user-agent specifications;
a data structure containing the plurality of URLs ready for action;
a data structure containing the plurality of pattern-matching rules that define a set of weighting factors for selecting an optimal user agent for exploring the remote network resource from a plurality of user agents;
a data structure containing the plurality of user-agent specifications;
a URL selection module with instructions for selecting a URL from the plurality of URLs ready for action;
a user-agent choosing module with instructions for choosing a user-agent to use in processing a URL based on the pattern-matching rules;
a user-agent driver with instructions for downloading or accessing a network resource using a given user-agent for a given URL;
a resource processing module with instructions for extracting a set of additional URLs from a downloaded or access network resource;
a URL submission module with instructions for submitting the set of additional URLs to a URL manager; and
a URL manager module with instructions for accepting and handling submitted URLs.

9. The machine of claim 8, further comprising a user-agent re-selection module with instructions for re-using the resource processing module with an alternative user-agent after downloading or accessing the network resource, wherein the alternative user-agent is selected by the re-selection module based on information retrieved from the user-agent driver.

10. The machine of claim 8, further comprising a user-agent re-selection module with instructions for re-submitting the URL to the URL manager with an alternative user-agent specification after downloading or accessing the network resource.

11. The machine of claim 10, wherein the user-agent re-selection module attempts to re-use the resource processing module with the alternative user-agent specification prior to re-submitting the URL to the URL manager with the alternative user-agent specification.
